(19) United States
(12) Patent Application Publication
(10) Pub. No.: US 2024/0264715 A1
(43) Pub. Date: Aug. 8, 2024

(54) Immersive Digital Map Navigation Using One Hand

(71) Applicant: GOOGLE LLC, Mountain View, CA (US)

(72) Inventors: Dmitrii Boiarshinov, Mountain View, CA (US); Gabi Lanning, Mountain View, CA (US); Jaime Guajardo, Mountain View, CA (US)

(21) Appl. No.: 18/017,007

(22) PCT Filed: Jul. 13, 2022
(86) PCT No.: PCT/US22/36904

§ 371 Date: Jan. 19, 2023

(51) Int. Cl. G06F 3/04815; G01C 21/36; G06F 3/0346; G06F 3/0485; G06T 7/536; G06T 7/73; G06T 15/20

(52) U.S. Cl. CPC G06F 3/04815; G01C 21/3602; G06F 3/0346; G06T 7/536; G06T 7/74; G06T 15/20; G06F 3/0485; G06F 2203/04806; G06T 2200/24; G06T 2207/30201

(57) ABSTRACT

To orient a user within a digital map using an immersive view at the user's location, a client device determines a location and orientation of a camera view of the client device. The client device then presents an immersive view of a three-dimensional (3D) map from a perspective of a virtual camera having an orientation and location matching the orientation and location of a camera view in the client device.

### FIELD OF TECHNOLOGY

This disclosure relates to interactive geographic applications and, more particularly, to providing an immersive view of a three-dimensional (3D) map from the same location and/or orientation as the user to orient the user within the map display.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A variety of computing devices support geographic software applications for displaying interactive digital maps of geographic areas. Many map applications provide the user with the ability to select the type of map information or features for viewing as well as to adjust the display of the digital map. For example, the user may select among several scales and map viewing modes, such as a basic map mode that presents a traditional road map view, a satellite mode, a street-level mode, or a three dimensional (3D) view.

Typically, when a user launches a mapping application, the mapping application may present a window defining a viewable portion of the digital map, which can be referred as to as “viewport.” of a geographic area which includes the user's current location. However, it can be difficult for the user to orient themselves within the viewport, for example to determine where they are relative to a building or point of interest (POI).

Additionally, the mapping application typically provides directional, rotational, and zoom controls for positioning the viewport over a desired location. For example, these controls can be provided in the form of buttons overlaying the digital map. As another example, a mapping application operating in a device equipped with a touchscreen can support user gestures, so that the user can pan across the digital map by swiping her finger in the desired direction, zoom in on an area by pinching two fingers together, zoom out on an area by spreading two fingers apart, rotate the digital map by rotating one finger while holding the other finger in place, tilt the digital map by sliding two fingers in the desired direction of tilt, etc.

### SUMMARY

To orient a user within a digital map, a user may point the camera view of a client device in the direction the user is facing. The client device may then determine its location and orientation via sensor data from sensors at the client device, such as a global positioning sensor (GPS), a compass, a gyroscope, an accelerometer, a transceiver, a camera, etc. Then the client device presents a 3D map of an immersive view from the perspective of a virtual camera having the same orientation and location as the camera view of the client device.

In some implementations, the client device may determine the initial zoom level for the immersive view based on the distance between the user and the client device. For example, the client device may identify the user's face in a front camera view and determine the distance between the user and the client device based on the size of the user's face in the camera view. If the user's face takes up the entire camera view, the client device may determine the user is closer to the client device than if the user's face takes up a small portion of the camera view, for example.

By presenting an immersive view of a 3D map from the orientation and/or location of the client device, the user may be able to orient themselves within the map to identify where they are with respect to particular buildings or points of interest (POIs). The user can then interact with the buildings or POIs in the 3D map, by for example selecting icons overlaying the POIs to view additional information about the POIs. Additionally, the user can pan or zoom the 3D map to view and interact with locations beyond the horizon.

Furthermore, the immersive view can be presented without needing to determine the location and/or orientation at the level of precision necessary for alternative systems, such as augmented reality systems. For example, in an augmented reality system, the location and/or orientation of the client device needs to be determined extremely precisely to overlay augmented reality icons over real-world objects. By contrast, the immersive view of the 3D map can be from the perspective of a virtual camera which is off slightly from the location and/or orientation of the camera view of the client device, and the user may still be able to orient themselves within the 3D map and interact with the 3D map. In this manner, the immersive view may be presented more frequently than alternative systems and the immersive view may be generated without requiring as much processing power to determine the user's precise location and/or orientation.

In some implementations, the user may also select a user control to view a two dimensional (2D) map having a particular viewport. To reposition the viewport of the 2D map or the immersive view of the 3D map without using finger gestures (which typically require one hand to hold the phone and the other to perform the gesture), a client device identifies a surface of a virtual plane for the 2D map or a surface of a virtual sphere surrounding the user for the 3D map. For example, the surface of the virtual plane may be located behind and parallel to the surface of the user interface on the client device. In other examples, the surface of the virtual plane may be tilted with respect to the surface of the user interface, as described in more detail below. In yet other examples, the surface of the virtual plane may be aligned with the ground. The surface of the virtual sphere may be a 360 degree view around the user, where the surface is a fixed distance from the user. In any event, the client device detects motion of the client device in a particular direction with respect to the surface of the virtual plane or the virtual sphere. Then the client device repositions the viewport of the digital map in accordance with the direction of movement of the client device.

In this manner, the user may reposition the viewport with one hand by holding the client device and moving it in a particular direction. While the client device may reposition the viewport by moving their entire body from one location to another, the user can also reposition the viewport as the user remains in place at the same location of within a threshold area (e.g., within a 5 meter radius, a 10 meter radius, etc.), only needing to move their hand. Accordingly, the client device does not need to use a positioning sensor such as a Global Positioning Service (GPS) sensor to detect movement of the client device which may have inaccuracies. Instead, the client device detects movement using sensors within the client device, such as an accelerometer, gyroscope, inertial measurement unit (IMU), compass, etc.

For example, if the viewport of the 2D map is positioned such that North is at the top of the digital map, when the user moves the client device upwards with respect to the surface of the virtual plane, the viewport pans the digital map to the north. When the user moves the client device downwards with respect to the surface of the virtual plane, the viewport pans the digital map to the south. When the user moves the client device to the left with respect to the virtual plane, the viewport pans the digital map to the west, and when the user moves the client device to the right with respect to the virtual plane, the viewport pans the digital map to the east. Additionally, when the user moves the client device inward toward the surface of the virtual plane, the viewport zooms in on the area depicted within the digital map, and when the user moves the client device outward away from the surface of the virtual plane, the viewport zooms out on the area depicted within the digital map. The user may also rotate or tilt the viewport by rotating or tilting the client device.

In another example, in the immersive view, when the user moves the client device upwards with respect to the surface of the virtual sphere, the viewport pans upwards toward the sky, the top of buildings, etc. When the user moves the client device downwards with respect to the surface of the virtual sphere, the viewport pans the immersive view downwards toward the ground. When the user moves the client device to the left with respect to the virtual sphere and the user is facing north, the viewport pans the immersive view to the northwest, and when the user moves the client device to the right with respect to the virtual sphere, the viewport pans the immersive view to the northeast. Additionally, when the user moves the client device inward toward the surface of the virtual sphere, the viewport zooms in on the area depicted within the immersive view, and when the user moves the client device outward away from the surface of the virtual sphere, the viewport zooms out on the area depicted within the immersive view. The user may pan the client device to focus on a particular building within the immersive view, for example. Then the user may move the client device inward to view the particular building at a larger scale.

In some implementations, the user may provide user controls to lock the position of the viewport or the position of the virtual camera for the immersive view as the user moves the client device. For example, the user may lock the position of the viewport or the immersive view by pressing a finger on the user interface and holding the finger on the user interface to keep the viewport or the immersive view in the lock position (e.g., a press and hold gesture), such that the position of the viewport or the position of the virtual camera for the immersive view does not change as the user's finger remains in contact with the user interface. Then when the user releases their finger, the position of the viewport or the position of the virtual camera for the immersive view may be unlocked and may continue to change in accordance with movement of the client device.

In this manner, the user may move the client device without panning, zooming, rotating, or tilting the viewport or the immersive view. For example, the user may move the client device to the right to pan the digital map to the east. If the user wants to view areas further east but cannot move their hand further to the right, the user may lock the position of the viewport and bring their hand back to the left toward their body. Then the user may release the lock position and continue to move their hand to the right to pan further to the east. Beneficially, this allows the user to pan around a digital map with ease, while minimizing movement of the user's hand and/or body. In other implementations, the viewport or the immersive view may default to the lock position. The user may unlock the position of the viewport or the immersive view by pressing and holding on the user interface and moving the client device as the user holds a finger on the user interface.

By repositioning the viewport of the digital map without needing to use finger gestures, the mapping application improves the user experience for the user making it more convenient to maneuver the digital map display. The user no longer has to use two hands and this frees up the user's other hand for additional activities, such as holding or carrying other objects. Additionally, the mapping application improves driver distraction by reducing the amount of focus that is necessary to maneuver the digital map display. For example, when a driver is looking at the digital map for directions, the driver does not need to take their hand off the wheel or take their focus away from the road to perform a multi-finger gesture to maneuver the digital map. Still further, the mapping application improves ease of use for people with disabilities, arthritis, or other neurological or neuromuscular disorders that effect their ability to control their fingers or use two hands.

One embodiment of these techniques is a method for orienting a user within a digital map using an immersive view at the user's location. The method includes determining a location of the client device, and determining an orientation of the client device. Additionally, the method includes presenting an immersive view of a three-dimensional (3D) map from a perspective of a virtual camera having an orientation and location matching the orientation and location of a camera view in the client device.

Another embodiment of these techniques is a client device for orienting a user within a digital map using an immersive view at the user's location. The client device includes a user interface, one or more processors coupled to the user interface, and a computer-readable medium storing instructions. The computer-readable medium may be non-transitory. When executed on the one or more processors, the instructions cause the client device to determine a location of the client device, and determine an orientation of the client device. The instructions further cause the client device to present, via the user interface, an immersive view of a three-dimensional (3D) map from a perspective of a virtual camera having an orientation and location matching the orientation and location of a camera view in the client device.

Another embodiment of these techniques is a method for generating an immersive view at a user's location to orient the user within a digital map. The method includes obtaining sensor data from one or more sensors in a client device, and determining an orientation and location of the client device based on the sensor data. The method further includes generating an immersive view of a three-dimensional (3D) map from a perspective of a virtual camera having an orientation and location matching the orientation and location of a camera view in the client device, and providing the immersive view for display via the client device.

### BRIEF DESCRIPTION OF THE DRAWINGS

FIG. 1 is a block diagram of an example system in which the techniques of this disclosure for orienting a user in a map display can be implemented;

FIG. 2 illustrates an example scenario where a user points the camera view of the user's client device at real-world imagery;

FIG. 3 illustrates another example scenario where a user points the camera view of the user's client device at real-world imagery, and the client device presents an immersive view of a 3D map with interactive controls from the same perspective as the camera view;

FIG. 4 illustrates an example scenario where the user moves the client device upwards toward the sky, and in response the immersive view pans upwards to show the top of a building;

FIG. 5 illustrates another example scenario where the user moves the client device inward toward the building, and in response the immersive view zooms in on the building to show the building at a larger scale;

FIG. 6 illustrates an example scenario where the client device presents a two dimensional (2D) map having a particular viewport defining a viewable portion of the 2D map;

FIG. 7 illustrates another example scenario where the user moves the client device to the right, and in response the viewport pans east;

FIG. 8 illustrates an example scenario where the user rotates the client device counterclockwise, and in response the viewport rotates such that the top of the digital map faces northwest instead of north;

FIG. 9 illustrates another example scenario where the user moves the client device inward toward the surface of a virtual plane and away from the user, and in response the viewport zooms in;

FIG. 10 illustrates yet another example scenario where the user moves the client device outward away from the surface of the virtual plane and toward the user, and in response the viewport zooms out;

FIG. 11 illustrates an example scenario where the user, while locking the position of the viewport, rotates the client device toward the user, and in response the virtual plane is tilted with respect to the surface of the client device;

FIG. 12 is a flow diagram an example method for orienting a user within a digital map using an immersive view at the user's location, which can be implemented by a client device; and

FIG. 13 is a flow diagram of an example method for generating an immersive view at a user's location to orient the user within a digital map, which can be implemented by a server device.

### DETAILED DESCRIPTION OF THE DRAWINGS

### Overview

Generally speaking, the techniques for orienting a user within a digital map can be implemented in one or several client devices, one or several network servers, or a system that includes a combination of these. However, for clarity, the examples below focus primarily on an embodiment in which a user positions the camera view of a client device to face the direction which the user is facing. A mapping application at the client device obtains sensor data from sensors in the client device, such as a positioning sensor (e.g., a global positioning system (GPS) sensor), a compass, a gyroscope, an accelerometer, a magnetometer, a transceiver that receives wireless signals from nearby devices, a rear camera that captures an image of the current rear camera view, a front camera that captures an image of the current front camera view, or any other suitable sensors within the client device. The mapping application may then analyze the sensor data to determine the location and orientation of the client device, and more specifically, the orientation of the rear camera view of the client device. The mapping application then transmits a request to a server device for an immersive view of a 3D map from the same perspective as the client device. In other implementations, the mapping application transmits the sensor data to the server device, and the server device analyzes the sensor data to determine the location and orientation of the client device. In yet other implementations, the client device does not obtain sensor data from a camera, and the rear camera pose of the client device is determined using other sensor data from the other sensors in the client device.

In any event, the server device may generate the immersive view of the 3D map by obtaining 3D map data from a map database having a virtual camera pose matching the rear camera pose of the client device. The server device may also select an initial zoom level for the immersive view based on the distance from the user to the front camera. For example, the client device may determine the distance from the user to the front camera based on a size of the user's face in the front camera view by analyzing the image of the current front camera view. In other implementations, the client device may transmit the image of the current front camera view to the server device, and the server device may determine the distance from the user to the front camera by analyzing the image of the current front camera view.

In any event, the server device then transmits the immersive view of the 3D map and/or 3D map data for the immersive view to the client device for display via the mapping application. In some implementations, the server device transmits additional immersive views at different zoom levels or orientations. In this manner, the user can pan or zoom the 3D map without the mapping application making additional server requests. The client device may then present the immersive view for the user to interact with a 3D map that is representative of the user's current location and orientation.

The term “pose” as used herein, may refer to the location and/or orientation of an object. For example, the pose of the camera may be a combination of the camera's current location and the direction the camera is facing, the pose of the camera may be the camera's current location, or the pose of the camera may be the direction the camera is facing.

### Example Hardware and Software Components

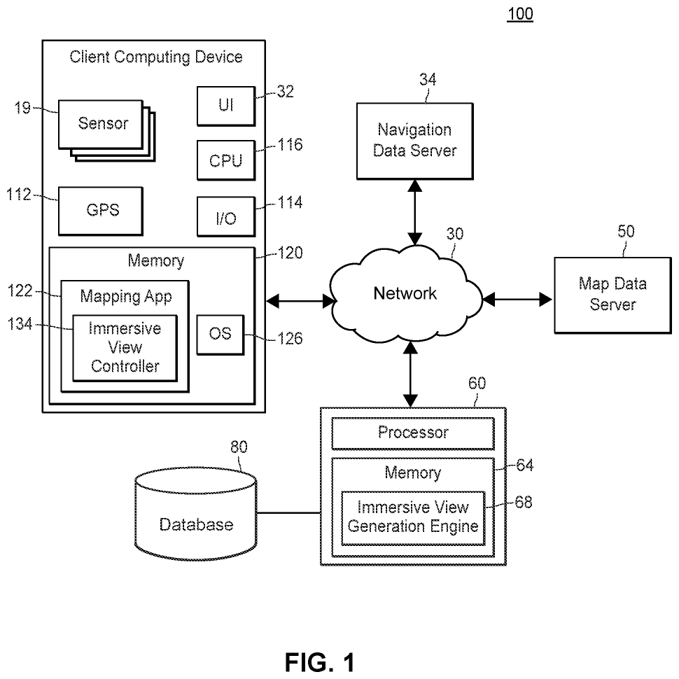

An example communication system 100 in which a map display orientation system can be implemented is illustrated in FIG. 1. The communication system 100 includes a client device 10 configured to execute a geographic application 122, which also can be referred to as “mapping application 122.” Depending on the implementation, the application 122 can display an interactive digital map, request and receive routing data to provide driving, walking, or other navigation directions including audio navigation directions, provide various geolocated content, etc. The client device 10 may be operated by a user displaying a 2D or 3D digital map while navigating to various locations.

In addition to the client device 10, the communication system 100 includes a server device 60 configured to provide immersive views and/or viewports to the client device 10. The server device 60 can be communicatively coupled to a database 80 that stores, in an example implementation, real-world imagery for various geographic areas. In this manner, the server device 60 may compare real-world imagery from a camera view of the client device 10 to the real-world imagery in the database 80 to identify the pose of the user. The database 80 may also store 3D map data for generating immersive views from particular virtual camera poses.

More generally, the server device 60 can communicate with one or several databases that store any type of suitable geospatial information or information that can be linked to a geographic context. The communication system 100 also can include a navigation data server 34 that provides navigation directions such as driving, walking, biking, or public transit directions, for example. Further, the communication system 100 can include a map data server 50 that provides 2D or 3D map data to the server device 60 for generating a map display. The devices operating in the communication system 100 can be interconnected via a communication network 30.

In various implementations, the client device 10 may be a smartphone or a tablet computer. The client device 10 may include a memory 120, one or more processors (CPUs) 116, a graphics processing unit (GPU) 112, an I/O module 114 including a microphone and speakers, a user interface (UI) 32, and one or several sensors 19 including a Global Positioning Service (GPS) module, a compass, a gyroscope, an accelerometer, a magnetometer, a camera, a transceiver, etc. The memory 120 can be a non-transitory memory and can include one or several suitable memory modules, such as random access memory (RAM), read-only memory (ROM), flash memory, other types of persistent memory, etc. The I/O module 114 may be a touch screen, for example. In various implementations, the client device 10 can include fewer components than illustrated in FIG. 1 or conversely, additional components. In other embodiments, the client device 10 may be any suitable portable or non-portable computing device. For example, the client device 10 may be a laptop computer, a desktop computer, a wearable device such as a smart watch or smart glasses, a virtual reality headset, etc.

The memory 120 stores an operating system (OS) 126, which can be any type of suitable mobile or general-purpose operating system. The OS 126 can include application programming interface (API) functions that allow applications to retrieve sensor readings. For example, a software application configured to execute on the computing device 10 can include instructions that invoke an OS 126 API for retrieving a current location of the client device 10 at that instant. The API can also return a quantitative indication of how certain the API is of the estimate (e.g., as a percentage).

The memory 120 also stores a mapping application 122, which is configured to generate interactive 2D and 3D digital maps and/or perform other geographic functions, as indicated above. The mapping application 122 can receive navigation instructions including audio navigation instructions and present the navigation instructions. The mapping application 122 also can display driving, walking, or transit directions, and in general provide functions related to geography, geolocation, navigation, etc.

The mapping application 122 may include an immersive view controller 134 which generates and transmits a request to the server device 60 for an immersive view of a 3D map. The request may include an indication of the pose of the rear camera view of the client device 10 or may include sensor data indicative of the pose of the rear camera view of the client device 10, such as real-world imagery from the rear camera, GPS data, accelerometer data, gyroscope data, compass data, magnetometer data, transceiver data that indicates the signal strengths of signals received from nearby wireless devices, etc.

The request may also include an indication of the distance between the user and the front camera view of the client device 10 or may include sensor data indicative of the distance between the user and the front camera view of the client device 10, such as real-world imagery from the front camera. The server device 60 may then analyze the real-world imagery from the front camera to identify the user in the front camera view for example, using face detection techniques. The server device 60 may then determine the distance from the user to the client device 10 based on for example, the size of the user's face in the front camera view.

Then the server device 60 may determine the pose of the virtual camera for the immersive view based on the pose of the rear camera view of the client device 10. The server device 60 may also determine an initial zoom level for the immersive view based on the distance from the user to the client device 10. Then the server device 60 may obtain an immersive view from the database 80 having a matching virtual camera pose and zoom level, and may provide the immersive view to the immersive view controller 134 for display.

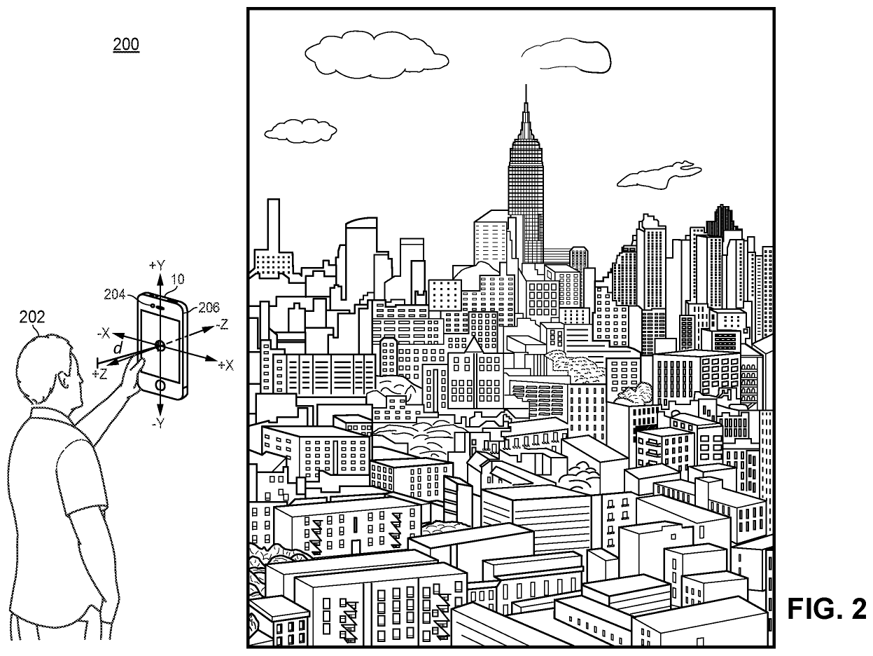

In addition to requesting and displaying immersive views, the immersive view controller 134 receives requests from the user to pan or zoom the immersive view or a viewport of a 2D map display, for example, when the user selects a user control to view the 2D map display. The immersive view controller 134 may generate a virtual sphere surrounding the user, as described in more detail below with reference to FIG. 2. For example, the virtual sphere may have a 1 meter radius surrounding the user.

Then when the user moves the client device 10 in a particular direction with respect to the virtual sphere, the immersive view controller 134 detects the movement via sensor data from the sensors 19 of the client device 10 such as the accelerometer or gyroscope, and pans the 3D map in the direction of movement of the client device 10. For example, when the user moves the client device 10 upwards with respect to the surface of the virtual sphere, the immersive view controller 134 pans the immersive view upwards toward the sky, the top of buildings, etc. In another example, when the user moves the client device 10 inward toward the surface of the virtual sphere, the immersive view controller 134 zooms in on the area depicted within the immersive view.

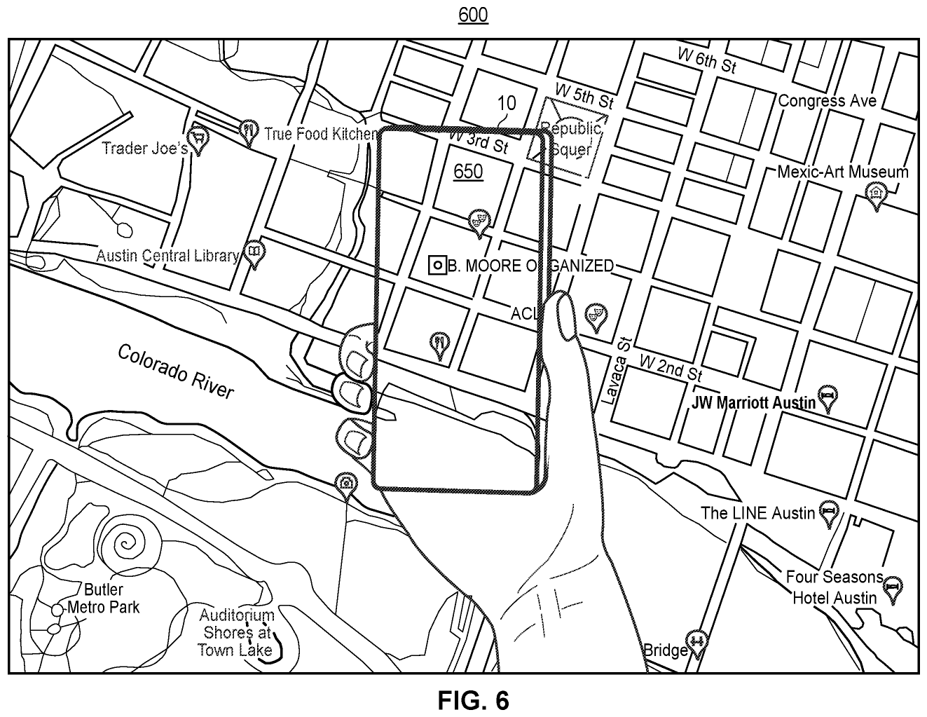

When the user selects a user control to view a 2D map display, the immersive view controller 134 may generate a virtual plane for the 2D map display, as described in more detail below with reference to FIG. 6. For example, the surface of the virtual plane may be located behind and parallel to the surface of the user interface 32 on the client device 10.

Then when the user moves the client device 10 in a particular direction with respect to the virtual plane, the immersive view controller 134 detects the movement via sensor data from the sensors 19 of the client device 10 such as the accelerometer or gyroscope, and pans the 2D map in the direction of movement of the client device 10. For example, when the user moves the client device 10 upwards with respect to the surface of the virtual plane, the immersive view controller 134 pans the viewport to the north when North is at the top of the digital map. In another example, when the user moves the client device 10 inward toward the surface of the virtual plane, the immersive view controller 134 zooms in on the area depicted within the viewport.

It is noted that although FIG. 1 illustrates the mapping application 122 as a standalone application, the functionality of the mapping application 122 also can be provided in the form of an online service accessible via a web browser executing on the client device 10, as a plug-in or extension for another software application executing on the client device 10, etc. The mapping application 122 generally can be provided in different versions for different respective operating systems. For example, the maker of the client device 10 can provide a Software Development Kit (SDK) including the mapping application 122 for the Android™ platform, another SDK for the iOS™ platform, etc.

In some implementations, the server device 60 includes one or more processors 62 and a memory 64. The memory 64 may be tangible, non-transitory memory and may include any types of suitable memory modules, including random access memory (RAM), read-only memory (ROM), flash memory, other types of persistent memory, etc. The memory 64 stores instructions executable on the processors 62 that make up an immersive view generation engine 68, which can generate an immersive view of a 3D map from a virtual camera pose matching the pose of a camera view (e.g., the rear camera view) in the client device 10.

In some implementations, the immersive view generation engine 68 receives a request for an immersive view of a 3D map from the client device 10. The request may include an indication of the pose of the rear camera view of the client device 10 or may include sensor data indicative of the pose of the rear camera view of the client device 10, such as real-world imagery from the rear camera, GPS data, accelerometer data, gyroscope data, compass data, magnetometer data, transceiver data that indicates the signal strengths of signals received from nearby wireless devices, etc.

When the request includes sensor data indicative of the pose of the rear camera view, the immersive view generation engine 68 determines the pose of the rear camera view based on the sensor data. For example, the immersive view generation engine 68 may determine the pose of the of the rear camera view by using a particle filter. For example, the immersive view generation engine 68 may determine a first pose with a first confidence level from the GPS sensor, a second pose with a second confidence level from the accelerometer, a third pose with a third confidence level from the gyroscope, a fourth pose with a fourth confidence level from the compass, a fifth pose with a fifth confidence level from the transceiver (e.g., where the location is determined based on the signal strength of signals emitted by nearby wireless beacons), etc. The particle filter may combine the poses and confidence levels from each of the sensors to generate a pose with a lower margin of error than the confidence levels for the individual sensors. The particle filter may combine the poses and confidence levels in any suitable manner, such as assigning weights to each of the poses. The particle filter may also generate probability distributions for the poses in accordance with their respective confidence levels (e.g., using a Gaussian distribution where the confidence level corresponds to two standard deviations). The particle filter may then combine the probability distributions for the poses using Bayesian estimation to calculate a minimum mean square (MMS) estimate.

More specifically, the particle filter may obtain N random samples of the probability distributions called particles to represent the probability distributions and assigns a weight to each of the N random samples. The particle filter then combines weighted particles to determine the pose having a confidence level with a lower margin of error than the confidence levels for the individual sensors.

Additionally, the immersive view generation engine 68 may determine the pose of the user by receiving a rear camera view or image from the rear camera of the client device 10, where the rear camera view depicts real-world imagery, such as buildings, streets, vehicles, and people within the field of view of the rear camera. The immersive view generation engine 68 may then determine a pose corresponding to the rear camera view.

More specifically, the immersive view generation engine 68 may compare the rear camera view to several template camera views stored in the database 80, for example. Each of the template camera views or images may be stored with an indication of the camera viewpoint or location from which the image was taken (e.g., a GPS location specifying latitude and longitude coordinates, a street address, etc.), an indication of the orientation of the camera when the image was taken (e.g., the camera was facing north, thereby indicating that the camera view depicts an area to the north of the viewpoint), indications of the scale or zoom level for the camera view, and/or an indication of a geographic area corresponding to the camera view including indications of precise physical locations at various positions within the camera view based on the scale or zoom level. The orientation of the camera may include a tri-axis orientation indicating the direction the camera is facing (e.g., east, west, north, south, etc.), the tilt angle of the camera (e.g., parallel to the ground), and whether the camera is in the horizontal or vertical position.

For example, for a template camera view, the camera viewpoint may be from the corner of Main Street and State Street, where the camera faced east. The template camera view may depict a width of 5 m, a length of 7 m, and a height of 3 m. The immersive view generation engine 68 may then create a mapping of the precise location of each pixel or group of pixels in the template camera view based on the camera viewpoint, camera orientation, and size of the template camera view. For example, if the template camera view is 5 m wide, the width of the image is 500 pixels, and the orientation of the template camera view is facing east and perpendicular to the ground, each pixel may represent a physical width of approximately 1 cm. The camera viewpoint for a template camera view may be determined from the GPS location of the client device that captured the camera view, and the orientation may be determined from a gyroscope and/or a compass included in the client device that captured the camera view.

In any event, the immersive view generation engine 68 may compare the rear camera view from the rear camera of the client device 10 to the template camera views to determine the camera viewpoint and/or orientation for the rear camera view based on the comparison. For example, the immersive view generation engine 68 may compare the rear camera view from the rear camera of the client device 10 to the template camera views using machine learning techniques, such as random forests, boosting, nearest neighbors, Bayesian networks, neural networks, support vector machines, etc.

More specifically, the immersive view generation engine 68 may identify visual features of each of the template camera views by detecting stable regions within the template camera view that are detectable regardless of blur, motion, distortion, orientation, illumination, scaling, and/or other changes in camera perspective. The stable regions may be extracted from the template camera view using a scale-invariant feature transform (SIFT), speeded up robust features (SURF), fast retina keypoint (FREAK), binary robust invariant scalable keypoints (BRISK), or any other suitable computer vision techniques. In some embodiments, keypoints may be located at high-contrast regions of the template camera view, such as edges within the template camera view. A bounding box may be formed around a keypoint and the portion of the template camera view created by the bounding box may be a feature.

The immersive view generation engine 68 may create numerical representations of the features to generate template feature vectors, such as the width and height of a feature, RGB pixel values for the feature, a pixel position of a center point of the feature within the image, etc. The immersive view generation engine 68 may then use the feature vectors as training data to create the machine learning model. If the machine learning technique is nearest neighbors, for example, the immersive view generation engine 68 may identify visual features of the rear camera view from the rear camera of the client device 10 to generate feature vectors. The immersive view generation engine 68 may then compare the feature vectors for the rear camera view from the rear camera of the client device 10 to the template feature vectors to identify a template camera view having the closest template feature vectors to the feature vectors for the rear camera view from the rear camera of the client device 10.

The immersive view generation engine 68 may then determine the camera viewpoint and/or orientation for the rear camera view as the camera viewpoint and/or orientation for the identified template camera view. In yet other implementations, the immersive view generation engine 68 may determine the pose of the rear camera view based on any suitable combination of the sensor data and a comparison of the rear camera view to template camera views. In other implementations, the client device 10 may determine the camera viewpoint and/or orientation for the rear camera view using the techniques described above and provide an indication of the pose of the rear camera view to the server device 60.

In addition to determining the pose of the rear view camera, the immersive view generation engine 68 may also determine the distance between the user and the front camera by for example, analyzing image(s) from the front camera view of the front camera. For example, the immersive view generation engine 68 may receive sensor data indicative of the distance between the user and the front camera from the client device 10, such as real-world imagery from the front camera. The immersive view generation engine 68 may then analyze the real-world imagery from the front camera to detect the user's face in the front camera view for example, using face detection techniques.

The immersive view generation engine 68 may then determine the size of the user's face relative to the size of the front camera view. For example, the immersive view generation engine 68 may identify the length of the user's face in pixels compared to the length of the front camera view. Then the immersive view generation engine 68 may determine the distance from the user to the client device 10 based on the size of the user's face relative to the size of the front camera view. For example, the size of the user's face relative to the size of the front camera view may be inversely proportional to the distance from the user to the client device 10. Then the immersive view generation engine 68 may determine an initial zoom level for the immersive view based on the distance from the user to the client device 10. As the distance between the user and the client device 10 increases, the zoom level decreases. In other implementations, the client device 10 may determine the distance from the user to the client device 10 using the techniques described above and provide an indication of the distance to the server device 60.

The immersive view generation engine 68 may then generate an immersive view having a virtual camera pose matching the pose of the rear camera view and an initial zoom level corresponding to the identified zoom level. Then the immersive view generation engine 68 may transmit the immersive view to the client device 10 for display. In some implementations, the immersive view generation engine 68 may compare the generated immersive view in the rear camera view from the rear camera of the client device 10. The immersive view generation engine 68 may determine a difference metric between the generated immersive view and the rear camera view for example, based on a pixel difference between the two views. The immersive view generation engine 68 may then determine that the generated immersive view is from the same pose as the rear camera view when the difference metric is below a threshold difference. In response to determining that the two views are from the same pose, the immersive view generation engine 68 may transmit the immersive view to the client device 10 for display. Otherwise, if the difference is greater than a threshold difference, the immersive view generation engine 68 may modify or change the immersive view. For example, the immersive view generation engine 68 may obtain a different immersive view from the database 80.

The immersive view generation engine 68 and the immersive view controller 134 can operate as components of a map display orientation system. Alternatively, the map display orientation system can include only server-side components and simply provide the immersive view controller 134 with immersive views to present. In other words, map display orientation techniques in these embodiments can be implemented transparently to the immersive view controller 134. As another alternative, the entire functionality of the immersive view generation engine 68 can be implemented in the immersive view controller 134.

For simplicity, FIG. 1 illustrates the server device 60 as only one instance of a server. However, the server device 60 according to some implementations includes a group of one or more server devices, each equipped with one or more processors and capable of operating independently of the other server devices. Server devices operating in such a group can process requests from the client device 10 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

### Example User Interfaces

FIG. 2 illustrates an example scenario where a user 202 points the camera view of the user's client device 10 at real-world imagery 200. The client device 10 may include a front camera 204 and a rear camera 206. The client device 10 includes sensors 19, such as accelerometers and gyroscopes to detect movement of the client device 10 in the X, Y, and Z directions, where the X direction is left and right with respect to the user 202, the Y direction is up and down with respect to the user 202, and the Z direction is toward and away from the user 202. The immersive view controller 134 may generate a virtual sphere around the user 202, for example with a radius matching the distance, d, from the user 202 to the client device 10. Then the immersive view controller 134 may detect motion, via the sensors 19, with respect to the surface of the virtual sphere, and may adjust the virtual camera pose and/or zoom level of the immersive view accordingly.

When the user 202 points the camera view of the rear camera 206 at real-world imagery 200, the user may select a user control via the mapping application 122 to view an immersive view of a 3D map having a virtual camera pose matching the camera pose of the rear camera 206. In some implementations, the mapping application 122 automatically generates an immersive view when the user 202 activates the rear camera 206 within the mapping application 122.

In any event, in response to receiving a selection of the user control, or the user 202 activating the rear camera 206 within the mapping application 122, the immersive view controller 134 obtains sensor data from the client device sensors 19, such as real-world imagery from the rear camera 206, GPS data, accelerometer data, gyroscope data, compass data, magnetometer data, transceiver data that indicates the signal strengths of signals received from nearby wireless devices, etc. The immersive view controller 134 then determines the pose of the rear camera 206 by analyzing the sensor data using the techniques described above, or sends the sensor data to the server device 60 to determine the pose of the rear camera 206.

The immersive view controller 134 also obtains sensor data for determining the distance, d, from the user 202 to the client device 10, such as real-world imagery from the front camera 206. Then the immersive view controller 134 determines the distance, d, from the user 202 to the client device 10 by analyzing the sensor data using the techniques described above, or sends the sensor data to the server device 60 to determine the distance, d, from the user 202 to the client device 10.

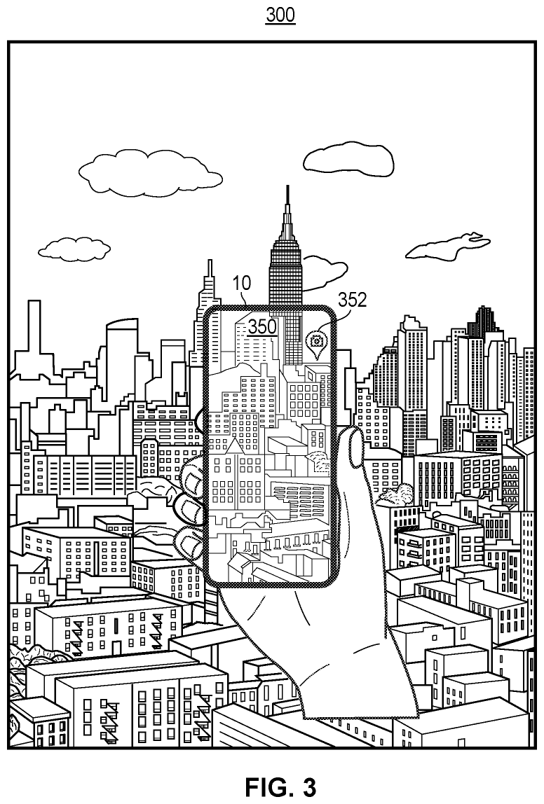

Then the server device 60 generates the immersive view and provides the immersive view for display via the user interface 32 of the client device 10. FIG. 3 illustrates presents an example immersive view 350 of a 3D map with interactive controls 352, where the immersive view 350 is from the same pose as the camera view of real-world imagery 300 in front of the rear camera 206. As shown in FIG. 3, the immersive view 350 displays imagery of buildings and streets similar to the real-world buildings and streets in front of the user. This allows the user to interact with a 3D map of the area directly in front of the user. For example, the user may select user controls, such as an icon 352 overlaying a building, which when selected, may provide additional information about the building. The user may also pan or zoom the immersive view to see locations off in the distance or at a larger scale from the scale in which the user can see the real-world locations. Further, if the user's view is blocked by a wall or building, the user may be able to see “through” the walls by viewing the immersive view 350 of the 3D map from the same pose as the rear camera 206 view.

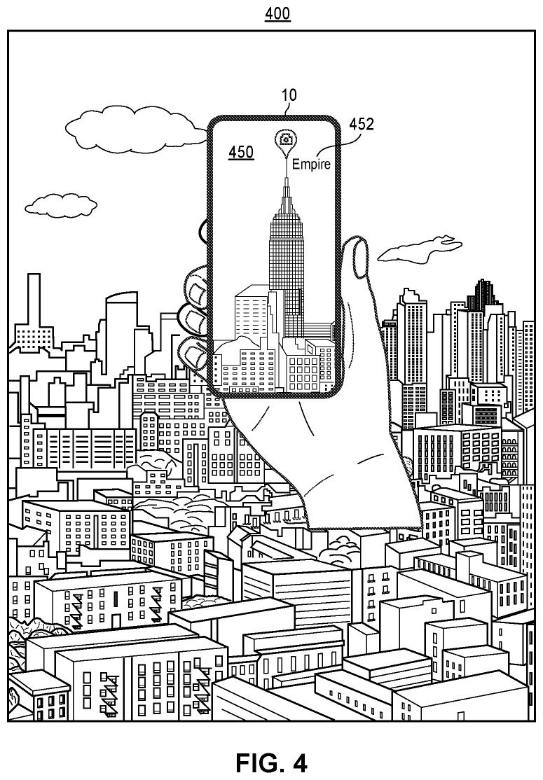

To pan or zoom the 3D map for immersive views at other virtual camera poses and/or zoom levels, the user can move the client device 10 in the X, Y, or Z directions. FIG. 4 illustrates an example immersive view 450 generated in response to the user moving the client device 10 upwards in the Y direction. In response, the client device 10 adjusts the immersive view 450 to display imagery of buildings and other locations above the locations displayed in the immersive view 350, The immersive view 450 includes imagery depicting the top of the Empire State Building with a label for the Empire State Building and a user control 452 for providing additional information about the Empire State Building. In some implementations, when the user pans the 3D map, the immersive view controller 134 sends a request to the server device 60 for an immersive view at the panned virtual camera pose. In other implementations, the immersive view controller 134 stores additional 3D map data for locations surrounding the area of the initial immersive view, and generates the new immersive view using the stored 3D map data.

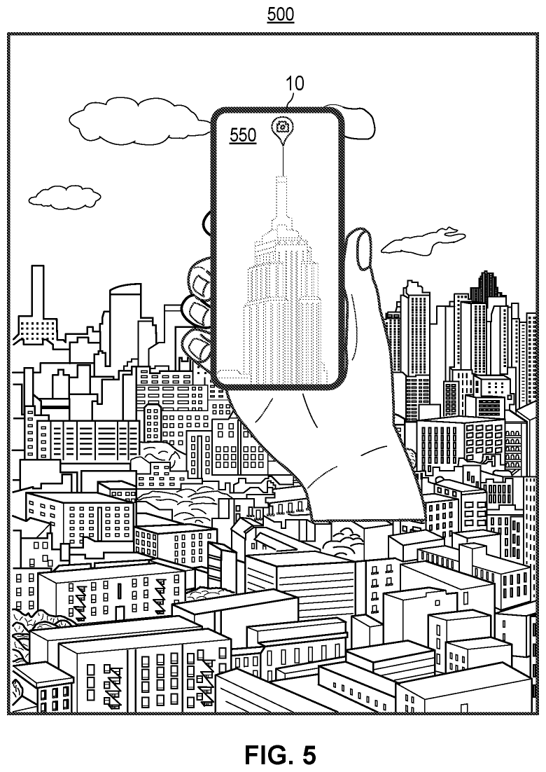

FIG. 5 illustrates an example immersive view 550 generated in response to the user moving the client device 10 away from the user in the Z direction and inward with respect to the surface of the virtual sphere. In response, the client device 10 adjusts the 3D map to display the Empire State Building in the immersive view 550 at a larger scale than in the immersive view 450. In some implementations, when the user zooms in or out on the 3D map, the immersive view controller 134 sends a request to the server device 60 for an immersive view at the adjusted zoom level. For example, the user may request to zoom the 3D map from a first zoom level to a second zoom level. Accordingly, the immersive view controller 134 sends a request to the server device 60 for an immersive view at the second zoom level. The server device 60 may generate a new immersive view of the 3D map for the second zoom level and provide the new immersive view to the immersive view controller 134 for display via the client device 10. In other implementations, the immersive view controller 134 stores additional 3D map data for multiple zoom levels for the area of the initial immersive view, and generates the new immersive view using the stored 3D map data.

By using an immersive view which is generated based on stored 3D map data, the visual quality of objects in the map, especially distant objects, may be improved as compared to the real world map. This is because the quality of the rear camera 206 of the client device 10 need not be related to the quality of the immersive view, and thus a high quality, detailed image may be consistently provided based on the 3D map data. Further, by generating a new immersive view at a new zoom level using the stored 3D map data, the visual detail of the immersive view may be improved yet further as compared to the real world map for which zoom quality may be severely limited by the quality of the rear camera 206 and/or other imaging devices, components or processes of the client device 10. As a result, the immersive view provides a consistent and improved detailed map view, regardless of zoom level and camera quality.

In some implementations, the user may select a user control to lock the virtual camera pose of the immersive view so that the immersive view does not change as the user moves the client device 10. The user control may be a press and hold gesture, for example, such that, as long as the user is holding a finger on the user interface 32 of the client device 10, the immersive view does not change. In other implementations, the immersive view may not change by default, and the user may have to perform a press and hold gesture while moving the client device 10 to pan or zoom the client device 10. By locking the virtual camera pose of the immersive view, the user can for example, pan to the right as far as the user can move their arm to the right. Then the user can lock the virtual camera pose as the user brings their arm back toward their body. Next, the user can unlock the virtual camera pose by for example, releasing the press and hold gesture. And can continue to pan further to the right by moving their arm to the right once again.

As mentioned above, in some implementations, the mapping application 122 includes a user control to view a 2D map of the area presented in the immersive view. For example, the user may perform a particular touch gesture on the user interface 32 to transition from the immersive view to the 2D map. In other implementations, the mapping application 122 may present a 2D map having a particular viewport by default.

FIG. 6 illustrates a 2D map 600 having a particular viewport 650 which is presented via the user interface 32 of the client device 10. As shown in FIG. 6, the particular viewport 650 is a viewable portion of the larger 2D map 600. In some implementations, the immersive view controller 134 generates a virtual plane which may be located behind and parallel to the surface of the user interface 32 on the client device 10. Then when the user moves the client device in a particular direction with respect to the virtual plane, the immersive view controller 134 adjusts the viewport accordingly.

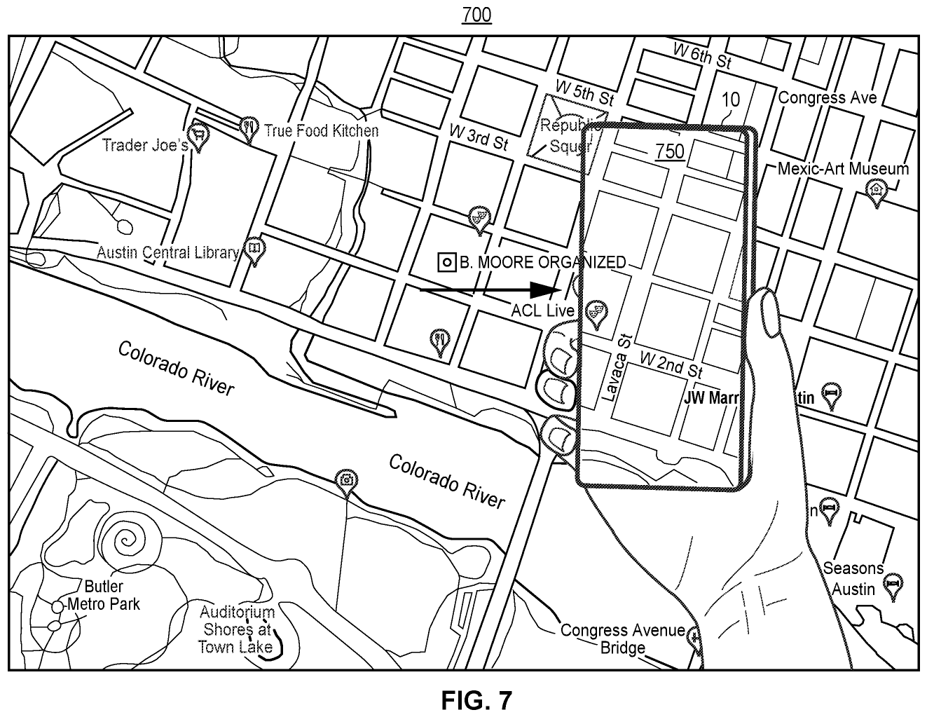

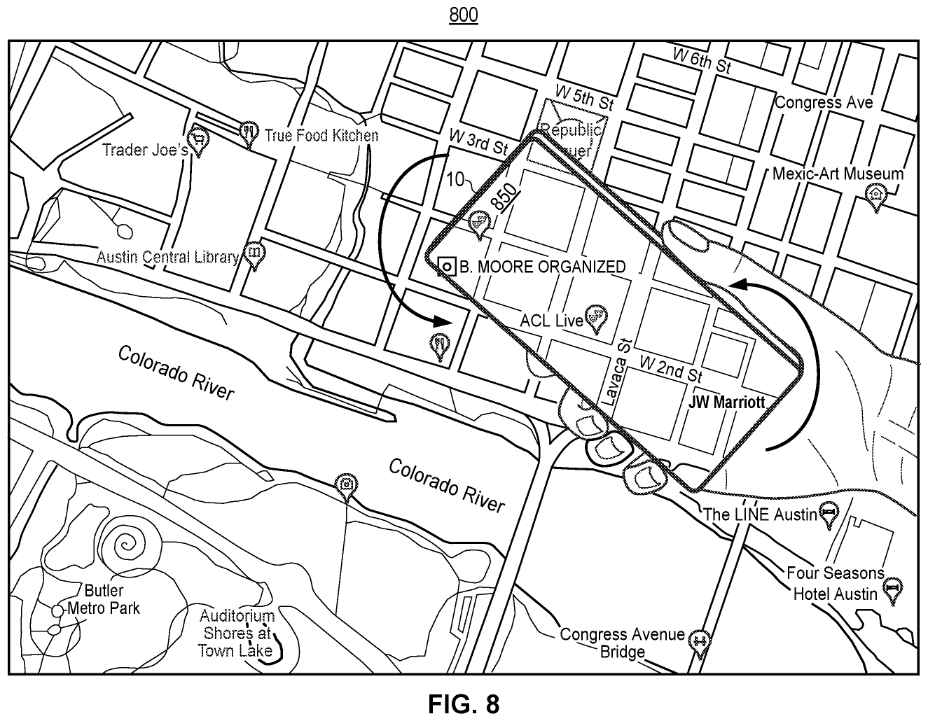

For example, FIG. 7 illustrates an example scenario where the user moves the client device 10 to the right in the X direction. Accordingly, the immersive view controller 134 adjusts the viewport 750 to present a portion of the 2D map 700 which is to the east of the viewport 650 when the viewport 750 is positioned such that North is at the top of the viewport 750. FIG. 8 illustrates an example scenario where the user rotates the client device 10 counterclockwise. In response, the immersive view controller 134 rotates the viewport 850 to present a portion of the 2D map 800, where the top of the viewport 850 faces northwest instead of north.

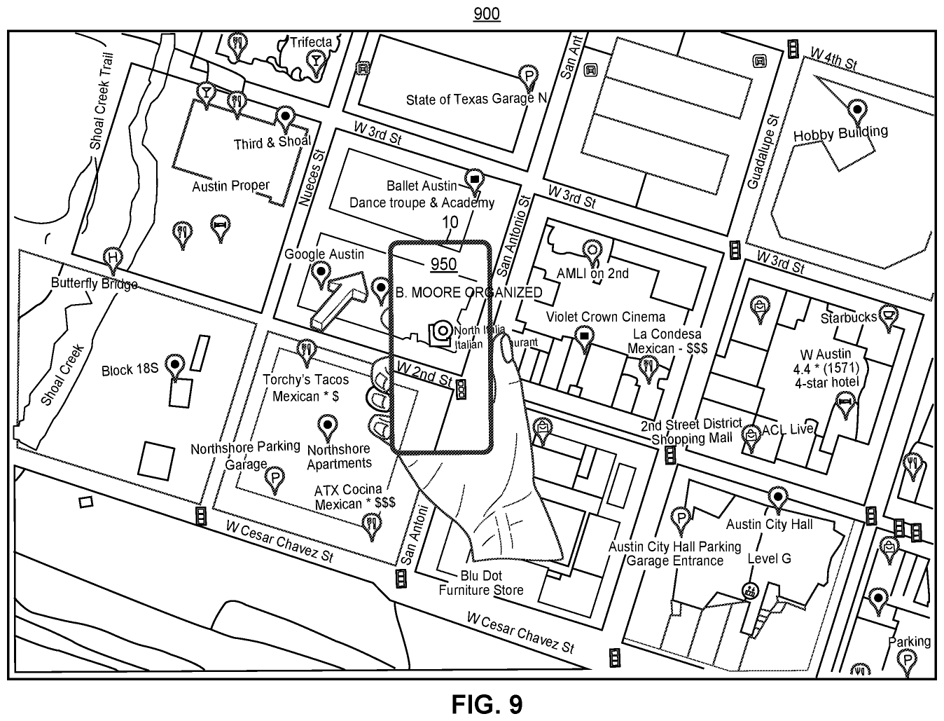

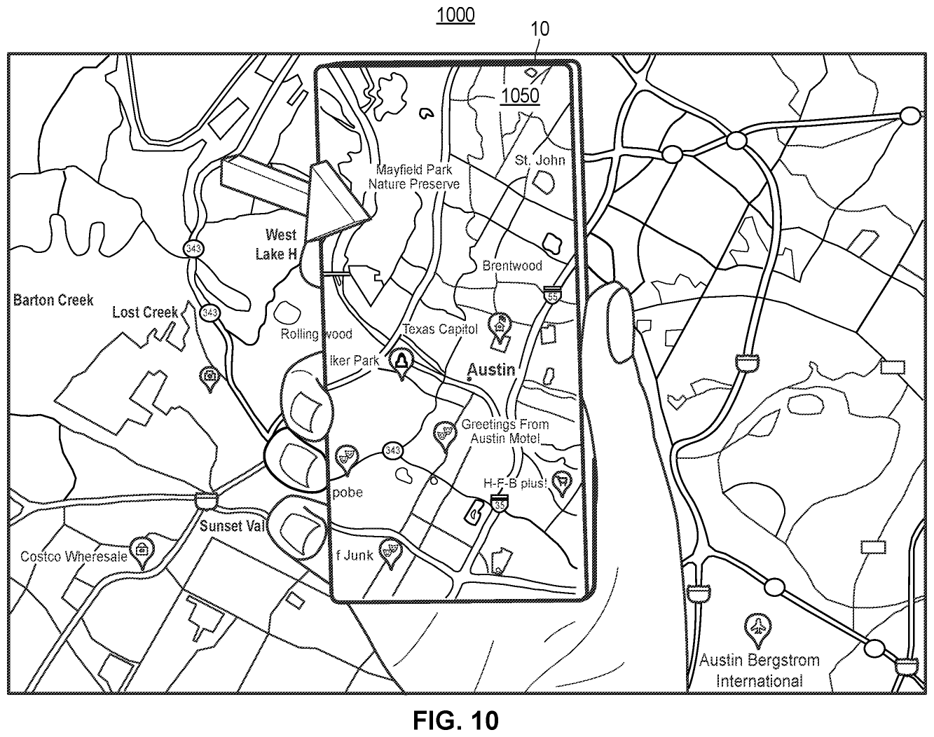

In another example, FIG. 9 illustrates an example scenario where the user moves the client device 10 inward toward the surface of a virtual plane in the Z direction. Accordingly, the immersive view controller 134 zooms in on the 2D map 900 to present a viewport 950 which is zoomed in compared to the viewport 650. FIG. 10 illustrates an example scenario where the user moves the client device 10 outward away from the surface of a virtual plane in the Z direction. Accordingly, the immersive view controller 134 zooms out on the 2D map 1000 to present a viewport 1050 which is zoomed out compared to the viewport 650.

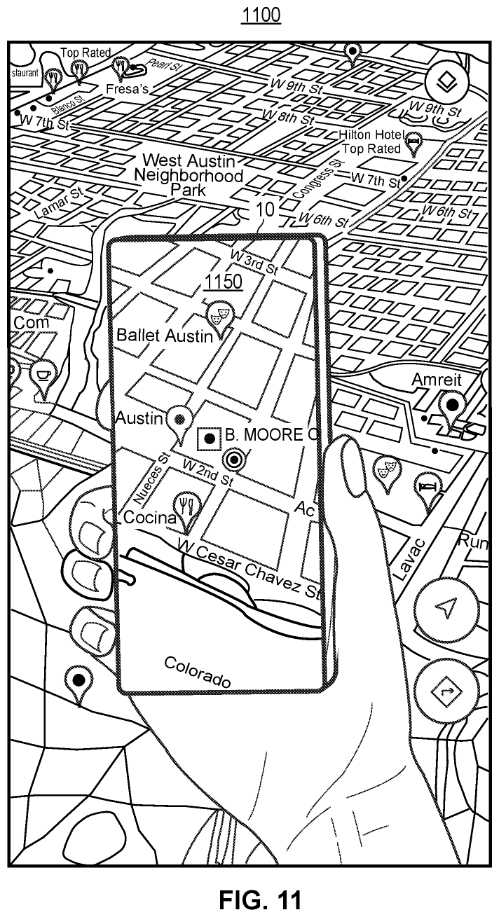

In yet another example, FIG. 11 illustrates an example scenario where the user, while locking the position of the virtual plane (e.g., via a user control), tilts the client device 10 toward the user. The user control may be the same as or different from the user control for locking the position of the viewport. Because the position of the virtual plane is locked, the position of the surface of virtual plane does not change. Accordingly, when the user tilts the client device 10 and the position of the surface of the virtual plane does not change, the surface of the virtual plane is tilted with respect to the client device 10. As a result, the immersive view controller 134 presents a tilted view of the viewport 1150, such that map features near the top of the viewport 1150 appear further away than map features near the bottom of the viewport 1150. In other implementations, the user does not need to lock the position of the viewport 1150 (e.g., via a user control) to tilt the viewport 1150 with respect to the surface of the virtual plane. Instead, the immersive view controller 134 by default locks the position of the virtual plane, and tilts the viewport 1150 in response to the user tilting the client device 10. In yet other implementations, the surface of the virtual plane may be parallel to the ground regardless of the tilt angle of the client device 10. In these implementations, the viewport does not tilt.

### Example Methods for Orienting a User in a Map Display

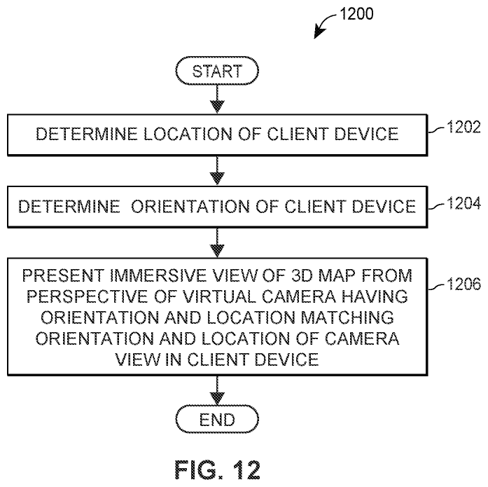

FIG. 12 illustrates a flow diagram of an example method 1200 for orienting a user within a digital map using an immersive view at the user's location. The method can be implemented in a set of instructions stored on a computer-readable memory and executable at one or more processors of the client device 10. For example, the method can be implemented by the immersive view controller 134 within the mapping application 122.

At block 1202, the immersive view controller 134 determines the location of the client device 10. The immersive view controller 134 may also determine the orientation of the client device 10. More specifically, the immersive view controller 134 may determine the location and orientation of the rear camera (the “rear camera pose”) of the client device 10. The immersive view controller 134 may determine the location and orientation by obtaining sensor data from the sensors 19 in the client device 10, such as real-world imagery from the rear camera, GPS data, accelerometer data, gyroscope data, compass data, magnetometer data, transceiver data that indicates the signal strengths of signals received from nearby wireless devices, etc. The immersive view controller 134 may then analyze the sensor data to determine the rear camera pose by for example, comparing real-world imagery from the rear camera to template camera view stored in the database 80, and/or by analyzing the GPS data, accelerometer data, gyroscope data, compass data, magnetometer data, transceiver data, etc., to determine the rear camera pose.

In other implementations, the immersive view controller 134 may transmit the sensor data to a server device 60 for the server device to analyze the sensor data to determine the rear camera pose. Then the server device 60 may provide an indication of the rear camera pose to the client device 10.

At block 1206, the immersive view controller 134 presents an immersive view of a 3D map from a perspective of a virtual camera having an orientation and location matching the orientation and location of the rear camera view in the client device 10. The immersive view controller 134 may transmit a request to the server device 60 for an immersive view of a 3D map. The request may include an indication of the pose of the rear camera view of the client device 10 or may include sensor data indicative of the pose of the rear camera view of the client device 10, such as real-world imagery from the rear camera, GPS data, accelerometer data, gyroscope data, compass data, magnetometer data, transceiver data that indicates the signal strengths of signals received from nearby wireless devices, etc.

The request may also include an indication of the distance between the user and the from camera view of the client device 10 or may include sensor data indicative of the distance between the user and the front camera view of the client device 10, such as real-world imagery from the front camera. The server device 60 may then analyze the real-world imagery from the front camera to identify the user in the front camera view for example, using face detection techniques and to determine the distance from the user to the client device 10 based on for example, the size of the user's face in the front camera view.

Then the server device 60) may determine the pose of the virtual camera for the immersive view based on the pose of the rear camera view of the client device 10. The server device 60 may also determine an initial zoom level for the immersive view based on the distance from the user to the client device 10. Then the server device 60 may obtain an immersive view from the database 80 having a matching virtual camera pose and zoom level, and may provide the immersive view to the immersive view controller 134 for display.

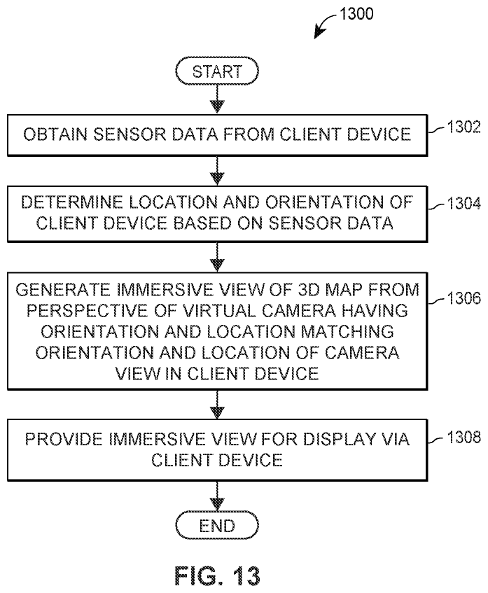

FIG. 13 illustrates a flow diagram of an example method 1300 for generating an immersive view at a user's location to orient the user within a digital map. The method can be implemented in a set of instructions stored on a computer-readable memory and executable at one or more processors of the server device 60. For example, the method can be implemented by the immersive view generation engine 68.

At block 1302, the immersive view generation engine 68 obtains sensor data from the client device 10. The sensor data may include real-world imagery from the rear camera, GPS data, accelerometer data, gyroscope data, compass data, magnetometer data, transceiver data that indicates the signal strengths of signals received from nearby wireless devices, etc. The sensor data may be obtained as part of a request for an immersive view of a 3D map from the perspective of the client device 10.

Then at block 1304, the immersive view generation engine 68 determines the location and orientation of the client device 10 based on the sensor data. For example, the immersive view generation engine 68 may compare real-world imagery from the rear camera to template camera view stored in the database 80. Additionally or alternatively, the immersive view generation engine 68 may analyze the GPS data, accelerometer data, gyroscope data, compass data, magnetometer data, transceiver data, etc., to determine the location and orientation of the client device 10.

At block 1306, the immersive view generation engine 68 generates an immersive view of a 3D map from a perspective of a virtual camera having an orientation and location matching the orientation and location of the rear camera view in the client device 10. For example, the immersive view generation engine 68 may generate the immersive view by obtaining 3D map data from a database 80 having a virtual camera pose matching the rear camera pose of the client device 10. Then at block 1308, the immersive view generation engine 68 provides the immersive view to the client device 10 for display. In some implementations, the immersive view generation engine 68 generates multiple immersive views for different zoom levels or virtual camera poses within the vicinity of the rear camera pose of the client device 10. The immersive view generation engine 68 provides the multiple immersive views to the client device 10, so that the user can pan or zoom the 3D map without the client device 10 needing to make additional requests to the server device 60 for immersive views within the same general area.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining.” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

Upon reading this disclosure, those of ordinary skill in the art will appreciate still additional alternative structural and functional designs for orienting a user within a map display through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for orienting a user within a digital map using an immersive view at the user's location, the method comprising:
determining, by one or more processors in a client device, a location of the client device;
determining, by the one or more processors, an orientation of the client device; and
presenting, by the one or more processors, an immersive view of a three-dimensional (3D) map from a perspective of a virtual camera having an orientation and location matching the orientation and location of a camera view in the client device.

2. The method of claim 1, wherein determining the orientation of the client device includes determining the orientation of a rear camera view of the client device.

3. The method of claim 1, further comprising:
determining, by the one or more processors, an initial zoom level for presenting the immersive view based on a distance between a user and the client device.

4. The method of claim 3, further comprising:
determining, by the one or more processors, the distance between the user and the client device based on a size of the user's face in a front camera view of the client device.

5. The method of claim 1, wherein determining the location and orientation of the client device includes:
receiving, at the one or more processors, sensor data at the client device from one or more sensors including at least one of: a positioning sensor, a compass, a gyroscope, an accelerometer, a transceiver, or a camera; and
determining, by the one or more processors, the location and orientation of the client device using the sensor data.

6. The method of claim 5, wherein determining the location and orientation of the client device using the sensor data includes:
providing, by the one or more processors, a real-world image from the camera view of the camera to a server device to compare the real-world image to a plurality of template real-world images from a plurality of locations and orientations stored in a real-world imagery database to identify at least one of the plurality of template real-world images which matches the real-world image from the camera and identify the location and orientation of the client device based on a location and orientation for the identified template real-world image.

7. The method of claim 1, further comprising:
detecting, by the one or more processors, that the client device has moved in a particular direction; and
repositioning, by the one or more processors, the immersive view based on the direction of movement of the client device.

8. The method of claim 7, wherein repositioning the immersive view based on the direction of movement of the client device includes:
identifying a surface of a virtual sphere surrounding a user;
panning the immersive view in the direction of movement of the client device with respect to the virtual sphere.

9. The method of claim 7, wherein repositioning the immersive view based on the direction of movement of the client device includes:
identifying a surface of a virtual sphere surrounding a user;
adjusting a zoom level of the viewport in response to detecting that the client device has moved toward or away from the surface of the virtual sphere.

10. The method of claim 1, further comprising:
receiving user input requesting to lock a position of the virtual camera for the immersive view to a current position;
detecting, by the one or more processors, that the client device has moved in a particular direction; and
presenting, by the one or more processors, the immersive view from the perspective of the virtual camera at the current position without repositioning the immersive view based on the direction of movement of the client device.

11. The method of claim 10, wherein the user input is a press and hold gesture on a user interface of the client device, and wherein the immersive view does not change position as the user's finger remains in contact with the user interface.

12. A client device for orienting a user within a digital map using an immersive view at the user's location, the client device comprising:
a user interface;
one or more processors; and
a computer-readable memory including computer executable instructions that, when executed by the one or more processors, cause the client device to:
determine a location of the client device;
determine an orientation of the client device; and
present, via the user interface, an immersive view of a three-dimensional (3D) map from a perspective of a virtual camera having an orientation and location matching the orientation and location of a camera view in the client device.

13. The client device of claim 12, wherein the orientation of the client device is determined based on an orientation of a rear camera view of the client device.

14. The client device of claim 12, wherein the instructions further cause the client device to:
determine an initial zoom level for presenting the immersive view based on a distance between a user and the client device.

15. The client device of claim 14, wherein the instructions further cause the client device to:
determine the distance between the user and the client device based on a size of the user's face in a front camera view of the client device.

16. The client device of claim 12, wherein to determine the location and orientation of the client device, the instructions cause the client device to:
receive sensor data from one or more sensors including at least one of: a positioning sensor, a compass, a gyroscope, an accelerometer, a transceiver, or a camera; and
determine the location and orientation of the client device using the sensor data.

17. A method for generating an immersive view at a user's location to orient the user within a digital map, the method comprising:
obtaining, at one or more processors, sensor data from one or more sensors in a client device;
determining, by the one or more processors, an orientation and location of the client device based on the sensor data;
generating, by the one or more processors, an immersive view of a three-dimensional (3D) map from a perspective of a virtual camera having an orientation and location matching the orientation and location of a camera view in the client device; and
providing, by the one or more processors, the immersive view for display via the client device.

18. The method of claim 17, wherein the one or more sensors include at least one of: a positioning sensor, a compass, a gyroscope, an accelerometer, a transceiver, or a camera.

19. The method of claim 17, wherein determining the orientation of the client device includes determining the orientation of a rear camera view of the client device.

20. The method of claim 17, further comprising:
determining, by the one or more processors, an initial zoom level for the immersive view based on a distance between a user and the client device.

21. The method of claim 17, further comprising:
receiving, by the one or more processors, a request to change a zoom level for the 3D map from a first zoom level to a second zoom level;
generating, by the one or more processors, a new immersive view of the 3D map for the second zoom level; and
providing, by the one or more processors, the new immersive view for display via the client device.
